(19) United States
(12) Patent Application Publication
(10) Pub. No.: US 2008/0186614 A1
(43) Pub. Date: Aug. 7, 2008

(54) LIBRARY APPARATUS AND TRANSFER MECHANISM FOR THE SAME

(75) Inventors: Yoshio Kotaki, Kawasaki (JP); Hidetaka Kaneko, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/023,231

(22) Filed: Jan. 31, 2008

(30) Foreign Application Priority Data
Feb. 6, 2007 (JP) JP2007-026848

(51) Int. Cl. G11B 17/00

(52) U.S. Cl. 360/69

(57) ABSTRACT

A transfer mechanism for a library apparatus enabling reduction in a size of the library apparatus. The transfer mechanism of the library apparatus includes first and second guide members extending parallel to a housing rack, a first transfer robot guided by the first and second guide members to move relative to the housing rack, and a second transfer robot guided by the first and second guide members to move relative to the housing rack.

### CROSS-REFERENCE TO RELATED APPLICATIONS

This application is related to and claims the benefit of priority from Japanese Patent Application No. 2007-26848, filed on Feb. 6, 2007, the entire contents of which are incorporated herein by reference.

### BACKGROUND

1. Field

The present invention relates to library apparatus(es) such as magnetic tape library apparatuses, and more particularly to a library apparatus having a housing rack with a plurality of cells, a first transfer robot that moves relative to the housing rack, and a second transfer robot that moves relative to the housing rack.

2. Description of the Related Art

Magnetic tape library apparatuses are widely known. A magnetic tape library apparatus includes first and second transfer robots. The first transfer robot moves relative to a housing rack. A vertically arranged guide shaft guides vertical movement of the first transfer robot. Also, another vertically arranged guide shaft guides vertical movement of the second transfer robot. Each transfer robot has a guide shaft. Generally, the vertical movement of the transfer robot uses a winding machine. A counterweight is coupled to the transfer robot.

Unfortunately, in a typical magnetic tape library apparatus, a housing space in a case is occupied by components including the guide shaft, the counterweight, the transfer robot, and a wire for coupling the counterweight. The case can be reduced in size if the occupied space of these components is reduced. It is desirable to have a magnetic tape library apparatus having a reduced size.

Accordingly, an object of the present invention is to provide a transfer mechanism of a library apparatus having a relatively reduced size in comparison to typical library apparatus.

### SUMMARY

The disclosed transfer mechanism for a library apparatus includes first and second guide members extending parallel to a housing rack, a first transfer robot guided by the first and second guide members to move relative to the housing rack, and a second transfer robot guided by the first and second guide members to move relative to the housing rack.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which.

FIG. 1 illustrates a perspective view schematically showing a structure of a library apparatus, or a magnetic tape library apparatus;

FIG. 2 illustrates a vertical sectional view showing a first nut member

FIG. 3 illustrates a vertical sectional view showing a second nut member;

FIG. 4 illustrates a partially enlarged, horizontal sectional view showing a relationship between a second guide member and a first rail base of a first transfer robot;

FIG. 5 illustrates a partially enlarged, horizontal sectional view showing a relationship between a second guide member and a first rail base of a second transfer robot;

FIG. 6 illustrates a side view showing a magnetic tape library apparatus, the view conceptually illustrating a movable range of first and second robot hands;

FIG. 7 illustrates a side view partially showing a magnetic tape library apparatus, the a view schematically illustrating first and second nut members meshing with each other; and

FIG. 8 illustrates a perspective view schematically showing a structure of a magnetic tape library apparatus.

### DETAILED DESCRIPTION OF THE PREFERRED EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

An embodiment of the present invention is described below with reference to the attached drawings.

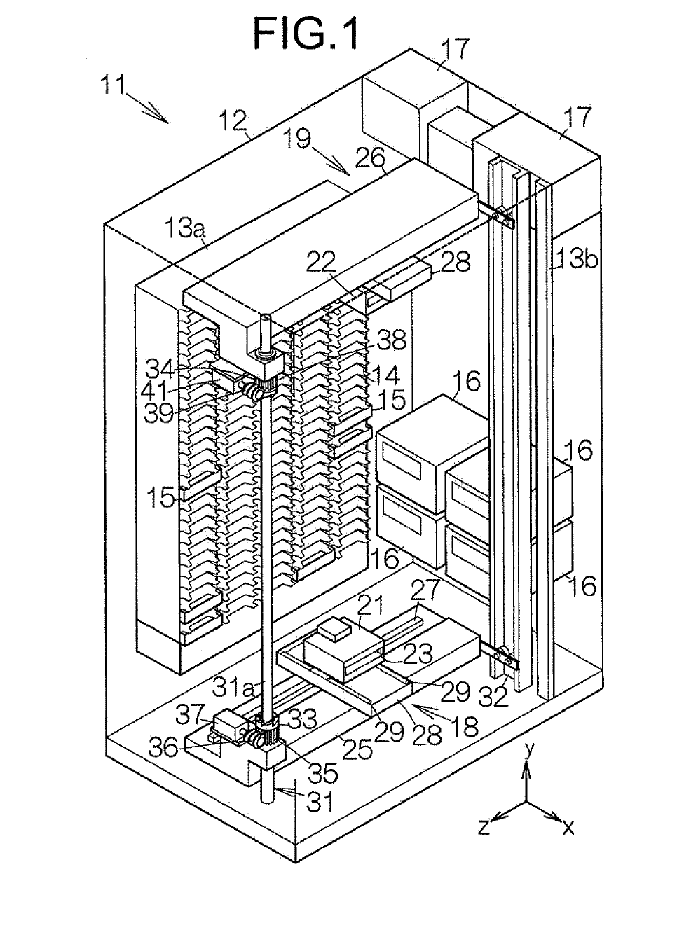

FIG. 1 schematically shows a library apparatus, or a magnetic tape library apparatus 11, according to an embodiment of the present invention. The magnetic tape library apparatus 11 has a box-like case 12. The case 12 has a rectangular-parallelepiped internal-space segment extending from, for example, a bottom surface. A plurality of housing racks 13a and 13b are arranged or provided in the internal space. A pair of housing racks 13a (one of them is not shown) face each other with, for example, a predetermined rectangular-parallelepiped space interposed therebetween. In the housing rack 13a, openings of cells 14 are arrayed in a plane vertically extending from the bottom surface, that is, along a side surface of the rectangular-parallelepiped space. Each cell 14 houses a storage article, or a storage medium like a magnetic tape cartridge 15. For example, the magnetic tape cartridge may be a Linear Tape-Open (LTO) cartridge or any storage unit useable to store data.

In the rectangular-parallelepiped space between the pair of housing racks 13a, a pair of housing racks 13b face each other. For example, four storage medium drivers, that is, four magnetic tape drivers 16 are arranged for each housing rack 1 3b. Slots of the magnetic tape drivers 16 are arranged in a plane vertically extending from the bottom surface, that is, along a side surface of the rectangular-parallelepiped space. The magnetic tape driver 16 can write magnetic data on a magnetic tape in the magnetic tape cartridge 15. Also, the magnetic tape driver 16 can read magnetic data from the magnetic tape in the magnetic tape cartridge 15. To write and read magnetic data, the magnetic tape cartridge 15 is inserted to and ejected from the slot of the magnetic tape driver 16. In the magnetic tape driver 16, a magnetic tape in the magnetic tape cartridge 15 is drawn from a reel in the magnetic tape cartridge 15 and wound around a reel of the magnetic tape driver 16.

A three-dimensional coordinate system, that is, an xyz coordinate system is determined in the rectangular-parallelepiped space. The y axis of the xyz coordinate system is perpendicular to the bottom surface. In the housing rack 13a, the cells 14 are arrayed in a row parallel to the vertical direction, or the y axis. The z axis of the xyz coordinate system extends parallel to the pair of housing racks 13a in the horizontal direction. In the housing rack 13a, the cells 14 are arranged in a plurality of rows along the horizontal direction, or the z axis. The x axis of the xyz coordinate system extends in the horizontal direction and parallel to the housing rack 13b. In the housing rack 13b, the magnetic tape drivers 16 are arranged along the horizontal direction, or the x axis.

For example, first and second housing boxes 17 are arranged in an internal space of the case 12. The first housing box 17 houses a library control board and a first control board. The second housing box 17 houses a second control board. The library control board is connected to an external host computer (not shown). The library control board and the first and second control boards perform various processes on the basis of data and commands input from the host computer.

First and second transfer robots 18 and 19 are arranged in the rectangular-parallelepiped space of the case 12. The first and second transfer robots 18 and 19 respectively have first and second robot hands 21 and 22 that move relative to the first and second housing racks 13a and 13b. The first and second robot hands 21 and 22 can transfer the magnetic tape cartridge 15 between each of the cells 14 and each of the magnetic tape drivers 16 to write and read data. When the magnetic tape cartridge 15 is transferred, the first robot hand 21 or the second robot hand 22 captures the magnetic tape cartridge 15 through a slot 23. When the magnetic tape cartridge 15 is passed to the cells 14, the first robot hand 21 or the second robot hand 22 can control a direction of the slot 23 to the opening of each of the cells 14. Similarly, the first robot hand 21 or the second robot hand 22 can control the direction of the slot 23 to the slot of each of the magnetic tape drivers 16.

The first transfer robot 18 has a first rail base 25. The first rail base 25 extends in a horizontal direction and parallel to the pair of housing racks 13a. The second transfer robot 19 has a first rail base 26. The first rail base 26 extends in the horizontal direction and parallel to the pair of housing racks 13a. The two first rail bases 25 and 26 are arranged in the vertical direction, or the y axis direction. The first rail base 26 of the second transfer robot 19 is disposed above the first rail base 25 of the first transfer robot 18. As described below, the first rail bases 25 and 26 can move in a vertical direction, or parallel to the y axis. The first rail base 26 of the second transfer robot 19 moves in the vertical direction in an area above the first rail base 25 of the first transfer robot 18.

The first rail bases 25 and 26 are arranged with first rails 27. Each first rail 27 is located at a position equivalently distant from the pair of housing racks 13a and 13a, that is, at an intermediate position between the pair of housing racks 13a and 13a, and extends in the horizontal direction and parallel to the housing racks 13a and 13a. Second rail bases 28 are respectively coupled to the first rails 27. Each second rail base 28 extends in the horizontal direction and parallel to the housing rack 13b. The second rail base 28 can move along the first rail 27 in the horizontal direction, or parallel to the z axis. For such movement, a given drive mechanism is coupled to each second rail base 28. For example, the drive mechanism may be composed of an endless belt coupled to the second rail base 28 and wound around a pair of pulleys at the first rail base 25 or 26, and a power source to control rotation of one of the pulleys. The power source may be an electric motor. Such a z-axis electric motor may be a stepping motor.

The second rail base 28 is arranged with a pair of second rails 29. Each second rail 29 extends in the horizontal direction and parallel to the housing rack 13b. The first and second robot hands 21 and 22 are coupled to the second rails 29. Accordingly, the first and second robot hands 21 and 22 can move in the horizontal direction along the second rails 29, or parallel to the x axis. Also, the first and second robot hands 21 and 22 can rotate around a given (predetermined) vertical axes at the second rails 29, or around rotation axes parallel to the y axis. For such movement and rotation, a seat (not shown) may be coupled to the pair of second rails 29. The seat can move in the horizontal direction, or in parallel to the x axis, with the guide of the second rails 29. For such movement, a given drive mechanism may be coupled to the seat. For example, a drive mechanism may be composed of an endless belt coupled to the seat and wound around a pair of pulleys at the second rail base 28, and a power source to control rotation of one of the pulleys. The power source may be an electric motor. Such an x-axis electric motor may be a stepping motor.

The first and second robot hands 21 and 22 are respectively mounted on the seats. The first and second robot hands 21 and 22 are coupled to the seats rotatably around the vertical axes. For such rotation of the robot hands 21 and 22, given drive mechanisms are coupled to the robot hands 21 and 22. For example, each drive mechanism may be composed of an endless belt wound around rotation shafts of the robot hand 21 or 22 and also around a pulley on the base, and a power source to control rotation of the pulley. The power source may be an electric motor. Such a rotation electric motor may be a stepping motor.

In the above-described magnetic tape library apparatus 11, the positions of the cells 14 are specified on the basis of the three-dimensional coordinate values of the xyz coordinate system, and the rotation angles around the rotation axis. The positions of first and second robot hands 21 and 22 of the first and second transfer robots 18 and 19 are determined on the basis of the three-dimensional coordinate values. Also, the directions of the first and second robot hands 21 and 22 are determined on the basis of the rotation angles. The first control board controls the positioning and rotation of the first robot hand 21 on the basis of the three-dimensional coordinate values and the rotation angles specified for the cells 14. The second control board controls the positioning and rotation of the second robot hand 22 on the basis of the three-dimensional coordinate values and the rotation angles specified for the cells 14. Since the positioning and rotation of the first and second robot hands 21 and 22 are controlled, the slot 23 of the first robot hand 21 or the second robot hand 22 can be precisely directed to the opening of the corresponding cell 14.

The first and second transfer robots 18 and 19 are coupled to a first guide member 31 at first ends of the first rail bases 25 and 26. The first and second transfer robots 18 and 19 are also coupled to a second guide member 32 at second ends of the first rail bases 25 and 26. The first and second guide members 31 and 32 extend from the bottom surface of the case 12 in the vertical direction and in parallel to the y axis. The first and second guide members 31 and 32 guide vertical movement of the first and second transfer robots 18 and 19.

The first guide member 31 has a screw shaft 31a. The screw shaft 31a is supported at the case 12, and is inhibited from rotating relative to the case 12. The screw shaft 31a meshes with first and second nut members 33 and 34 respectively arranged at the first rail bases 25 and 26. As the first nut member 33 rotates around the central axis of the screw shaft 31a, the first nut member 33 can move in the vertical direction along the screw shaft 31a by the action of screw. As the second nut member 34 rotates around the central axis of the screw shaft 31a, the second nut member 34 can move in the vertical direction along the screw shaft 31a.

A helical gear 35 is threaded at a cylindrical outer periphery of the first nut member 33. The helical gear 35 meshes with a screw gear 36. As the screw gear 36 rotates around its central axis, the rotational force of the screw gear 36 is transmitted to the helical gear 35. The screw gear 36 is fixed to a drive shaft of an electric motor 37. The screw gear 36 is rotated by the driving force of the electric motor 37. The driving force of the electric motor 37 is transmitted to the first nut member 33 through the screw gear 36 and the helical gear 35. The first nut member 33 can move up and down in accordance with the rotation direction of the electric motor 37. Accordingly, a gear mechanism is provided between the first nut member 33 and the electric motor 37.

A helical gear 38 is threaded at the cylindrical outer periphery of the second nut member 34. The helical gear 38 meshes with a screw gear 39. As the screw gear 39 rotates around its central axis, the rotational force of the screw gear 39 is transmitted to the helical gear 38. The screw gear 39 is fixed to a drive shaft of an electric motor 41. The screw gear 39 is rotated by the driving force of the electric motor 41. The driving force of the electric motor 41 is transmitted to the second nut member 34 through the screw gear 39 and the helical gear 38. The second nut member 34 can move up and down in accordance with the rotation direction of the electric motor 41. Accordingly, a gear mechanism is provided between the second nut member 34 and the electric motor 41.

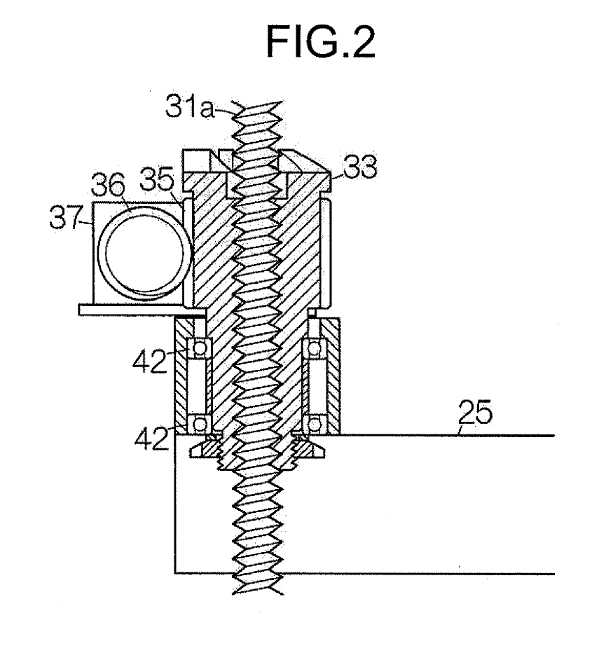

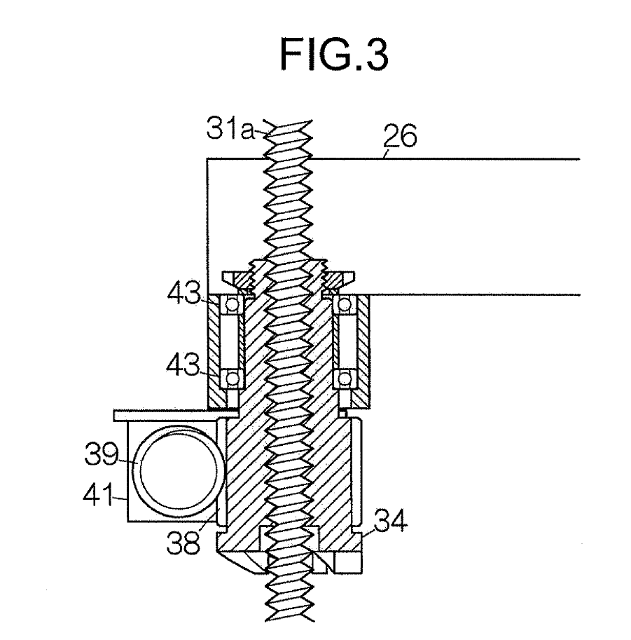

As shown in FIG. 2, the first nut member 33 is rotatably fixed to the first rail base 25 of the first transfer robot 18 (FIG. 1). For the fixture, for example, ball bearings 42 are interposed between the first nut member 33 and the first rail base 25. As shown in FIG. 3, the second nut member 34 is rotatably fixed to the first rail base 26 of the second transfer robot 19. For the fixture, for example, ball bearings 43 are interposed between the second nut member 34 and the first rail base 26.

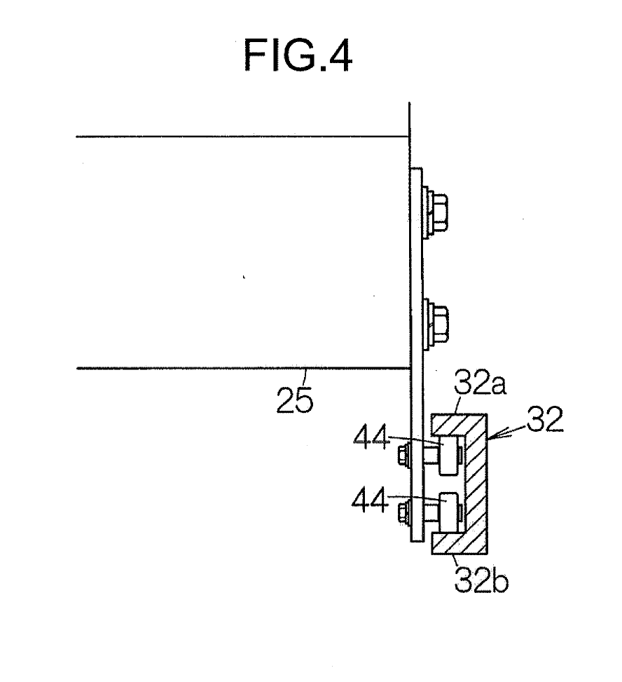

As shown in FIG. 4, the second guide member 32 includes a first regulation plate 32a extending in the vertical direction and in parallel to the y axis along an imaginary vertical plane containing the central axis of the screw shaft 31a. Also, the second guide member 32 includes a second regulation plate 32b extending in the vertical direction and in parallel to the y axis along an imaginary plane containing the central axis of the screw shaft 31a. The second regulation plate 32b faces the first regulation plate 32a with a predetermined distance interposed therebetween.

A pair of rotation rollers 44 are disposed between the first and second regulation plates 32a and 32b. The pair of rotation rollers 44 are supported by the first rail base 25 of the first transfer robot 18. Each rotation roller 44 has, for example, a rotation axis in an imaginary vertical plane containing the central axis of the screw shaft 31a. One of the rotation rollers 44 contacts the first regulation plate 32a. The other one of the rotation rollers 44 contacts the second regulation plate 32b. Accordingly, the first rail base 25 is inhibited from rotating in any rotation direction around the central axis of the screw shaft 31a.

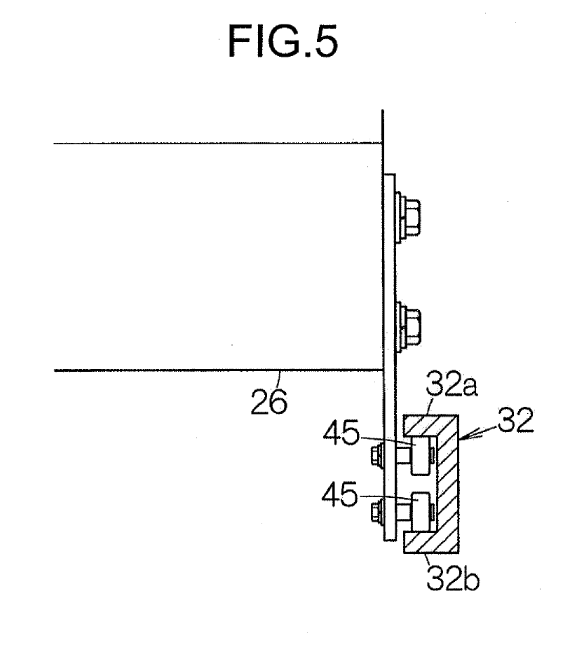

As shown in FIG. 5, a pair of rotation rollers 45 are disposed between the first and second regulation plates 32a and 32b. The pair of rotation rollers 45 are supported by the first rail base 26 of the second transfer robot 19. Each rotation roller 45 has, for example, a rotation axis in an imaginary vertical plane containing the central axis of the screw shaft 31a. In the pair of rotation rollers 45, similarly to the above-mentioned pair of rotation rollers 44, one of the rotation rollers 45 contacts the first regulation plate 32a. The other one of the rotation rollers 45 contacts the second regulation plate 32b. Accordingly, the first rail base 26 is inhibited from rotating in any rotation direction around the central axis of the screw shaft 31a.

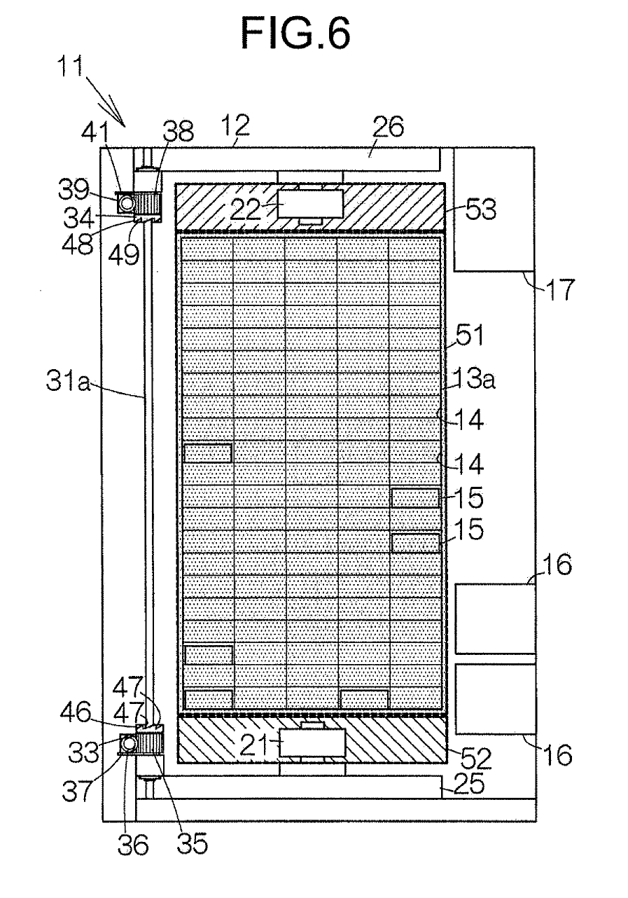

As shown in FIG. 6, the first nut member 33 has a first toothed surface 46 facing the second nut member 34. The first toothed surface 46 has a vertical surface 47 expanding along an imaginary vertical plane containing the central axis of the screw shaft 31a. The vertical surface 47 may be provided every predetermined central angle. The second nut member 34 has a second toothed surface 48 facing the first nut member 33. The second toothed surface 48 has a vertical surface 49 expanding along an imaginary vertical plane containing the central axis of the screw shaft 31a. The vertical surface 49 may be provided every predetermined central angle. The vertical surface 47 of the first toothed surface 46 faces the vertical surface 49 of the second toothed surface 48 when the first nut member 33 rotates around the screw shaft 31a and moves up. The vertical surface 49 of the second toothed surface 48 faces the vertical surface 47 of the first toothed surface 46 when the second nut member 34 rotates around the screw shaft 31a and moves down. Accordingly, a coupling unit is provided between the first and second nut members 33 and 34.

As shown in FIG. 6, the positions of the first and second robot hands 21 and 22 are determined in an operation area 51 with respect to the cells 14. In the operation area 51, the slot 23 of the first robot hand 21 or second robot hand 22 can be directed to any of the cells 14. Also, the magnetic tape library apparatus 11 has predetermined retraction areas 52 and 53 for the first and second robot hands 21 and 22. The retraction area 53 adjacent to the upper limit of the operation area 51 is allocated for the second robot hand 22. At this time, the first rail base 26 of the second transfer robot 19 is positioned at the upper limit of the screw shaft 31a. When the second robot hand 22 is positioned at the retraction area 53, the second robot hand 22 is retracted from the operation area 51. Accordingly, the positioning of the first robot hand 21 is available at any of the cells 14 in the operation area 51. In this way, a movable range of the second robot hand 22 is determined by the operation area 51 and the retraction area 53.

The retraction area 52 adjacent to a lower limit of the operation area 51 is allocated for the first robot hand 21. At this time, the first rail base 25 of the first transfer robot 18 is positioned at the lower limit of the screw shaft 31a. When the first robot hand 21 is positioned at the retraction area 52, the first robot hand 21 is retracted from the operation area 51. Accordingly, the positioning of the second robot hand 22 is available at any of the cells 14 in the operation area 51. In this way, the movable range of the first robot hand 21 is determined by the operation area 51 and the retraction area 52. In the magnetic tape library apparatus 11, since the housing racks 13a and 13b are closely arranged, the first and second robot hands 21 and 22 may contact the housing racks 13a and 13b at predetermined three-dimensional coordinate values and at predetermined rotation angles. Such three-dimensional coordinate values and the rotation angles are eliminated from the movable ranges of the first and second robot hand 21 and 22 during operation.

In the magnetic tape library apparatus 11, the first transfer robot 18 is normally operated on the basis of an instruction of the library control board. The first robot hand 21 transfers the magnetic tape cartridges 15 between the cells 14 and the magnetic tape drivers 16. For transferring, the first control board gives drive signals to the electric motor 37, z-axis electric motor, x-axis electric motor, and rotation electric motor. The electric motor 37 drives the first nut member 33 to rotate in response to reception of the drive signals. Since the first rail base 25 is inhibited from rotating around the screw shaft 31a by the action of the second guide member 32, the first rail base 25 does not rotate even while the first nut member 33 rotates. The first nut member 33 rotates relative to the first rail base 25. As a result, the first rail base 25 moves up and down along the first guide member 31.

For example, when the first robot hand 21 breaks down in the operation area 51, the library control board instructs the operation of the second transfer robot 19. The second control board gives drive signals to the electric motor 41, z-axis electric motor, x-axis electric motor, and rotation electric motor. The electric motor 41 drives the second nut member 34 to rotate in response to reception of the drive signals. Since the first rail base 26 is inhibited from rotating around the screw shaft 31a by the action of the second guide member 32, the first rail base 26 does not rotate even while the second nut member 34 rotates. The second nut member 34 rotates relative to the first rail base 26. As a result, the first rail base 26 moves up and down along the first guide member 31.

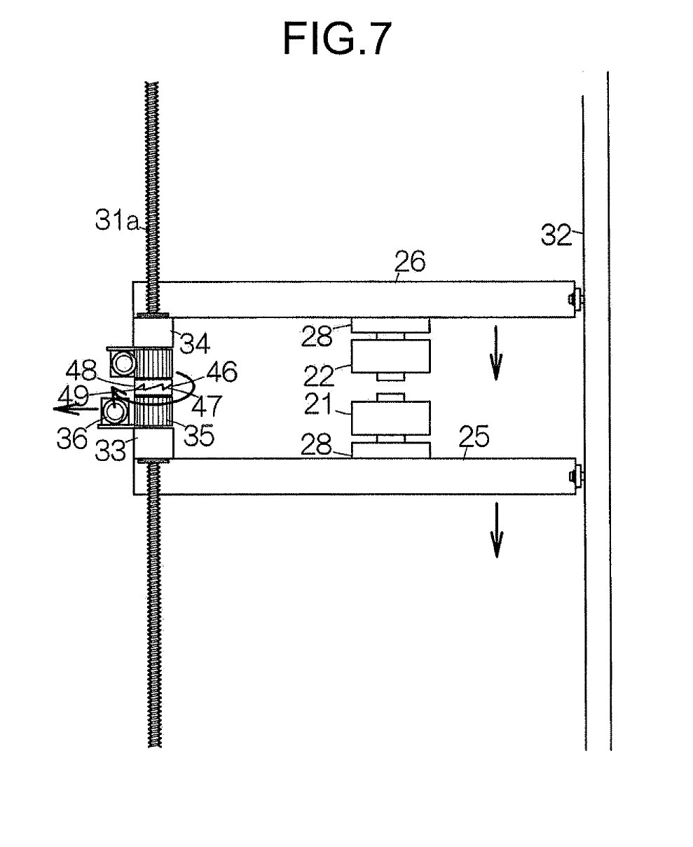

At this time, for example as shown in FIG. 7, the first rail base 26 of the second transfer robot 19 moves down. When the second nut member 34 contacts the first nut member 33, the vertical surface 49 of the second toothed surface 48 is received by the vertical surface 47 of the first toothed surface 46. Accordingly, the second nut member 34 meshes with the first nut member 33. The rotation of the second nut member 34 is transmitted to the first nut member 33. The first nut member 33 rotates with the second nut member 34. The first rail base 25 of the first transfer robot 18 moves down along the first guide member 31. Hence, the first transfer robot 18 is pushed out from the operation area 51. The first transfer robot 18 is transferred to the retraction area 52. As shown in FIG. 7, with the rotation of the first nut member 33, the screw gear 36 may be detached from the helical gear 35.

Then, the second robot hand 22 transfers the magnetic tape cartridges 15 between the cells 14 and the magnetic tape drivers 16. The second transfer robot 19 does not interfere with the first transfer robot 18 as long as the second robot hand 22 moves within the operation area 51.

In this case, the first transfer robot 18 can be repaired while the second transfer robot 19 is operated. For example, the first robot hand 21 of the first transfer robot 18 may be replaced with new one. After the replacement, the first transfer robot 18 may be immediately operated instead of the second transfer robot 19. Or, the second transfer robot 19 may be continuously operated. When the second robot hand 22 breaks down during the operation of the second transfer robot 19, similarly to the above description, the second robot hand 22 is retracted to the retraction area 53 by the action of the first transfer robot 18. Then, the first robot hand 21 is operated instead of the second robot hand 22. The first transfer robot 18 does not interfere with the second transfer robot 19 as long as the first robot hand 21 moves within the operation area 51.

In the above-described magnetic tape library apparatus 11i the first guide member 31 and the second guide member 32 are shared by the first transfer robot 18 and the second transfer robot 19. The sharing of the components allows the number of components to be reduced. As a result, procurement cost of the components can be reduced. In addition, the space occupied by the guide members in the case 12 can be reduced as compared with a case where the first transfer robot 18 and the second transfer robot 19 each have a dedicated guide member. The case 12 thus can be small. Further, the up and down movement of the first transfer robot 18 or second transfer robot 19 does not rely upon a winding machine. Accordingly, a winding machine or a counterweight is not necessary. Thus, the space occupied by the winding machine or the counterweight can be omitted.

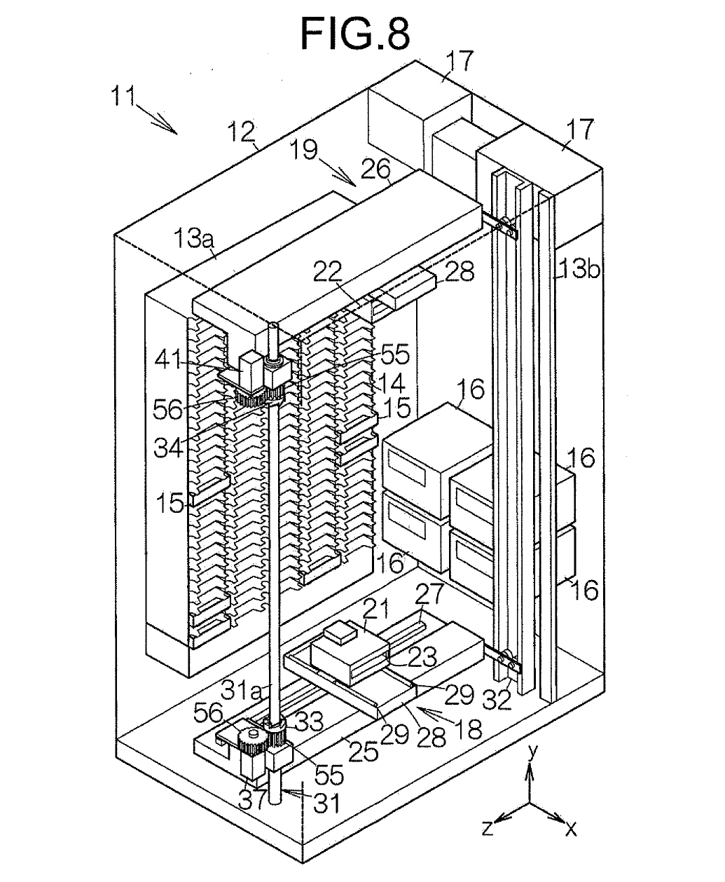

In the magnetic tape library apparatus 11, for example as shown in FIG. 8, first and second spur gears 55 and 56 may be used instead of the above-mentioned helical gears 35 and 38, and the screw gears 36 and 39. The first spur gears 55 are threaded at the cylindrical outer peripheries of the nut members 33 and 34. The second spur gears 56 are fixed to the drive shafts of the electric motors 37 and 41. The second spur gears 56 mesh with the corresponding first spur gears 55. Accordingly gear mechanisms are provided between the nut member 33 and the electric motor 37, and between the nut member 34 and the electric motor 41. At this time, the drive shafts of the electric motors 37 and 41 may extend in parallel to the central axis of the screw shaft 31a. Alternatively, the screw shaft 31a, and the first and second nut members 33 and 34 may be made of ball screws. The ball screws may reduce friction between the screw shaft 31a, and the nut members 33 and 34.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A transfer mechanism for a library apparatus, comprising:
first and second guide members extending parallel to a housing rack;
a first transfer robot guided by the first and second guide members to move relative to the housing rack; and
a second transfer robot guided by the first and second guide members to move relative to the housing rack.

2. The transfer mechanism for the library apparatus according to claim 1, comprising,
a screw shaft provided at the first of said guide members;
a first nut member provided at the first transfer robot and meshing with the screw shaft;
a first drive motor provided at the first transfer robot and applying a rotational force around a central axis of the screw shaft to the first nut member;
a second nut member provided at the second transfer robot and meshing with the screw shaft; and
a second drive motor provided at the second transfer robot and applying a rotational force around the central axis of the screw shaft to the second nut member.

3. The transfer mechanism for the library apparatus according to claim 2, wherein a gear mechanism is provided between the first nut member and the first drive motor.

4. The transfer mechanism for the library apparatus according to claim 3, wherein the gear mechanism includes:
a helical gear formed at an outer periphery of the first nut member, and a screw gear coupled to the first drive motor and meshing with the helical gear.

5. The transfer mechanism for the library apparatus according to claim 2, wherein a gear mechanism is provided between the second nut member and the second drive motor.

6. The transfer mechanism for the library apparatus according to claim 5, wherein the gear mechanism includes:
a helical gear formed at an outer periphery of the second nut member, and a screw gear coupled to the second drive motor and meshing with the helical gear.

7. The transfer mechanism for the library apparatus according to claim 2, comprising.
a coupling unit provided between the first nut member and the second nut member, where the coupling unit couples the first nut member with the second nut member around the screw shaft when a rotation causing movement of the first nut member toward the second nut member is applied to the first nut member.

8. The transfer mechanism for the library apparatus according to claim 7, wherein the coupling unit includes first and second vertical surfaces respectively provided at the first nut member and the second nut member and facing each other with an imaginary plane containing the central axis of the screw shaft interposed therebetween.

9. A library apparatus, comprising;
a housing rack with a plurality of cells;
first and second guide members extending parallel to the housing rack;
a first transfer robot guided by the first and second guide members to move relative to the housing rack; and
a second transfer robot guided by the first and second guide members to move relative to the housing rack.

10. The library apparatus according to claim 9, comprising:
a screw shaft provided at the first of said guide members;
a first nut member provided at the first transfer robot and meshing with the screw shaft;
a first drive motor provided at the first transfer robot and applying a rotational force around a central axis of the screw shaft to the first nut member;
a second nut member provided at the second transfer robot and meshing with the screw shaft; and
a second drive motor provided at the second transfer robot and applying a rotational force around the central axis of the screw shaft to the second nut member.

11. The library apparatus according to claim 10, wherein a gear mechanism is provided between the first nut member and the first drive motor.

12. The library apparatus according to claim 11, wherein the gear mechanism includes:
a helical gear formed at an outer periphery of the first nut member, and a screw gear coupled to the first drive motor and meshing with the helical gear.

13. The library apparatus according to claim 10, wherein a gear mechanism is provided between the second nut member and the second drive motor.

14. The library apparatus according to claim 13, wherein the gear mechanism includes:
a helical gear formed at an outer periphery of the second nut member, and a screw gear coupled to the second drive motor and meshing with the helical gear.

15. The library apparatus according to claim 10, comprising:
a coupling unit is provided between the first nut member and the second nut member, where the coupling unit couples the first nut member with the second nut member around the screw shaft when a rotation causing movement of the first nut member toward the second nut member is applied to the first nut member.

16. The library apparatus according to claim 15, wherein the coupling unit includes first and second vertical surfaces respectively provided at the first nut member and the second nut member and facing each other with an imaginary plane containing the central axis of the screw shaft interposed therebetween.

17. A transfer control method of a library apparatus, comprising:
controlling a direction of a slot towards an opening of a cell among a plurality of cells each housing a storage medium, where first and second transfer robots share guides to rotate around a predetermined vertical axes in accordance with said controlling.
